(19) United States
(12) Patent Application Publication
(10) Pub. No.: US 2008/0010523 A1
(43) Pub. Date: Jan. 10, 2008

(54) Performance Testing Despite Non-Conformance

(76) Inventor: Samik Mukherjee, Oak Park, CA (US)

Correspondence Address: SoCAL IP LAW GROUP LLP, 310 N. WESTLAKE BLVD. STE 120, WESTLAKE VILLAGE, CA, 91362, US

(21) Appl. No.: 11/383,106

(22) Filed: May 12, 2006

(51) Int. Cl. G06F 11/00

(52) U.S. Cl. 714/25

(57) ABSTRACT

There is disclosed apparatus and methods for testing performance of a system under test. The test is performance according to a standard. The system under test does not conform to the standard, but the non-conformance may be irrelevant to the test. There may be provided set up parameters and daemons which cover over the non-conformance, allowing the test to proceed.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to performance testing of networks, network segments and network apparatus.

2. Description of the Related Art

Although strict adherence to industry standards is necessary for perfect interoperability, many products are made which do not fully comply with applicable industry standards. For many industry standards, there is a certification organization. Even when a certification organization encourages conformance, historical and market forces often lead to industry standards which are widely adopted but which are not strictly followed. Two such standards in the telecom industry are IPSec and L2TPv3.

IPSec operates according to a state machine defined in an RFC. Opening an IPSec tunnel involves two steps. First, the two sides exchange their public keys. Second, the two sides negotiate the tunnel. The RFC for the second step is well defined and conformance is near universal. However, vendors implement the first step in different ways. Though IPSec is a standard, adherence is optional. As a result, the IPSec products of many vendors are not interoperable.

The differences in key exchange arise in two ways. First, some vendors utilize non-standard parameter sets. Second, some vendors perform key exchange in non-standards ways. Some non-standard implementations arose before the RFC was adopted. Other non-standard implementations arise because vendors are seeking to improve upon the RFC and differentiate their products in what otherwise amounts to a generic market.

L2TPv3 is a relatively new standard with a long gestation. Thus, like IPSec, it suffers from non-standard implementations which arose prior to adoption of the standard, and it already suffers from non-standard implementations which arose after adoption.

### DESCRIPTION OF THE DRAWINGS

FIG. 1 is a block diagram of a test environment.

FIG. 2 is a block diagram of a performance testing apparatus.

FIG. 3 is a flow chart of a process for testing performance.

### DETAILED DESCRIPTION

Throughout this description, the embodiments and examples shown should be considered as exemplars, rather than limitations on the apparatus and methods disclosed or claimed.

The problems with non-conforming IPSec and L2TPv3 implementations arise from two sources. One is that a vendor uses non-standard parameters. The other is that vendors use non-standard processes. These problems may be handled somewhat or entirely separately.

These problems also arise with other standards. Thus, a solution for IPSec and L2TPv3 can be applied to other situations where vendors have non-conforming implementations of an RFC or other standard.

By “standard” it is meant a single, definite rule or set of rules for operation of information technology systems, and which is established by authority. A standard may be promulgated, for example, by a government agency, by an industry association, or by an influential player in a market. Standards may be “industry standards”, which are voluntary, industry-developed requirements for products, practices, or operations. Standards bodies include IEEE, ANSI, ISO and IETF (whose adoption of RFCs make them standards).

Most standards include definitions of what it means to comply with the standard. Some standards have rules which are required and also rules which are optional (e.g., merely recommended or suggested). As used herein, something “complies with” or “conforms to” a standard if it obeys all of the required rules of the standard.

The Test Environment

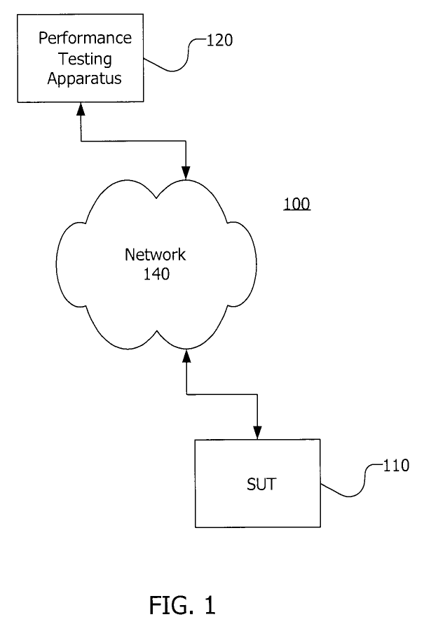

Referring now to FIG. 1, there is shown a block diagram of a test environment 100. The test environment includes a system under test (SUT) 110, a performance testing apparatus 120, and a network 140 which connects the SUT and the performance testing apparatus.

The performance testing apparatus 120, the SUT 110, and the network 140 may support, one or more well known high level communications standards or protocols such as, for example, one or more versions of the User Datagram Protocol (UDP), Transmission Control Protocol (TCP), Real-Time Transport Protocol (RTP), Internet Protocol (IP), Internet Control Message Protocol (ICMP), Internet Group Management Protocol (IGMP), Session Initiation Protocol (SIP), Hypertext Transfer Protocol (HTTP), address resolution protocol (ARP), reverse address resolution protocol (RARP), file transfer protocol (FTP), Simple Mail Transfer Protocol (SMTP); may support one or more well known lower level communications standards or protocols such as, for example, 10 Gigabit Ethernet, Fibre Channel, IEEE 802, Asynchronous Transfer Mode (ATM), X.25, Integrated Services Digital Network (ISDN), token ring, frame relay, Point to Point Protocol (PPP), Fiber Distributed Data Interface (FDDI), Universal Serial Bus (USB), IEEE 1394; may support proprietary protocols; and may support other protocols and standards.

The performance testing apparatus 120 may include or be one or more of a performance analyzer, a conformance validation system, a network analyzer, a packet blaster, a network management system, a combination of these, and/or others. The performance testing apparatus 120 may be used to evaluate and/or measure performance of the SUT 110.

The performance testing apparatus 120 may take various forms, such as a chassis, card rack or an integrated unit. The performance testing apparatus 120 may include or operate with a console. The performance testing apparatus 120 may comprise a number of separate units which may be local to or remote to one another. The performance testing apparatus 120 may be implemented in a computer such as a personal computer, server or workstation. The performance testing apparatus 120 may be used alone or in conjunction with one or more other performance testing apparatuses. The performance testing apparatus 120 may be located physically adjacent to and/or remote from the SUT 110.

The performance testing apparatus 120 may include software and/or hardware for providing functionality and features described herein. A performance testing apparatus may therefore include one or more of: logic arrays, memories, analog circuits, digital circuits, software, firmware, and processors such as microprocessors, field programmable gate arrays (FPGAs), application specific integrated circuits (ASICs), programmable logic devices (PLDs) and programmable logic arrays (PLAs). The hardware and firmware components of the performance testing apparatus may include various specialized units, circuits, software and interfaces for providing the functionality and features described here. The processes, functionality and features may be embodied in whole or in part in software which operates on a general purpose computer and may be in the form of firmware, an application program, an applet (e.g., a Java applet), a browser plug-in, a COM object, a dynamic linked library (DLL), a script, one or more subroutines, or an operating system component or service. The hardware and software and their functions may be distributed.

The SUT 110 may be or include one or more networks and network segments; network applications and other software; endpoint devices such as computer workstations, personal computers, servers, portable computers, set-top boxes, video game systems, personal video recorders, telephones, personal digital assistants (PDAs), computing tablets, and the like; peripheral devices such as printers, scanners, facsimile machines and the like; network capable storage devices such as NAS and SAN; network testing equipment such as analyzing devices, network conformance systems, emulation systems, network monitoring devices, and network traffic generators; and network infrastructure devices such as routers, relays, firewalls, hubs, switches, bridges, traffic accelerators, and multiplexers. Depending on the type of SUT, various aspects of its performance may be tested.

As used herein, a “performance test” is a test to determine how a SUT performs in response to specified conditions. A performance test is either a stress test or a load test, or some combination of the two. A performance test, in the context of network testing, refers to testing the limits of either control plane (session) or data plane (traffic) capabilities or both of the SUT. This is true irrespective of the network layer the protocol (being tested) operates on and applies to both the hardware and software implementations in the devices that are part of the SUT.

In a stress test, the performance testing apparatus 120 subjects the SUT 110 to an unreasonable load while denying it the resources (e.g., RAM, disk, processing power, etc.) needed to process that load. The idea is to stress a system to the breaking point in order to find bugs that will make that break potentially harmful. In a stress test, the SUT is not expected to adequately process the overload, but to behave (i.e., fail) in a decent manner (e.g., not corrupting or losing data). Bugs and failure modes discovered under stress testing may or may not be repaired depending on the SUT, the failure mode, consequences, etc. The load (incoming transaction stream) in stress testing is often deliberately distorted so as to force the SUT into resource depletion.

In a load test, the performance testing apparatus 120 subjects the SUT 110 to a statistically representative load. In this kind of performance testing, the load is varied, such as from a minimum (zero) to normal to the maximum level the SUT 110 can sustain without running out of resources or having transactions suffer excessive delay. A load test may also be used to determine the maximum sustainable load the SUT can handle.

The characteristics determined through performance testing may include: capacity, setup/teardown rate, latency, throughput, no drop rate, drop volume, jitter, and session flapping. As used herein, a performance test is on the basis of sessions, tunnels, and data transmission and reception abilities.

To better understand performance testing, it may be helpful to describe some other kinds of tests. In a conformance test, it is determined if a SUT conforms to a specified standard. In a compatibility test, two SUTs are connected and it is determined if they can interoperate properly. In a functional test, it is determined if the SUT conforms to its specifications and correctly performs all its required functions. Of course, a test or test apparatus may combine one or more of these test types.

The network 140 may be a local area network (LAN), a wide area network (WAN), a storage area network (SAN), or a combination of these. The network 140 may be wired, wireless, or a combination of these. The network 140 may include or be the Internet. The network 140 may be public or private, may be a segregated test network, and may be a combination of these. The network 140 may be comprised of a single or numerous nodes providing numerous physical and logical paths for data units to travel. The network 140 may simply be a direct connection between the performance testing apparatus 120 and the SUT 110.

Communications on the network 140 may take various forms, including frames, cells, datagrams, packets, higher level logical groupings of data, or other units of information, all of which are referred to herein as data units. Those data units that are communicated between the performance testing apparatus 120 and the SUT 110 are referred to herein as network traffic. The network traffic may include data units that represent electronic mail messages, computer files, web pages, graphics, documents, audio and video files, streaming media such as music (audio) and video, telephone (voice) conversations, and others.

The Performance Testing Apparatus 120

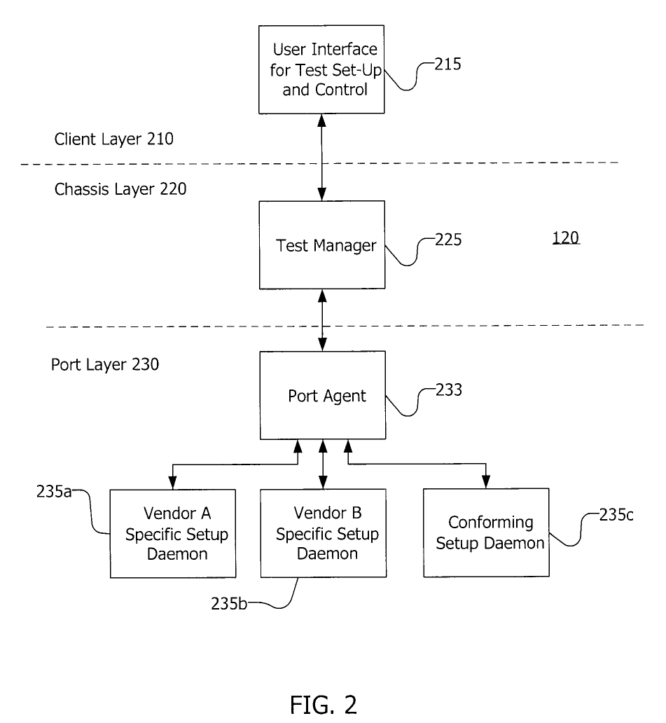

Referring now to FIG. 2, there is shown a block diagram of the performance testing apparatus 120. The performance testing apparatus 120 includes three layers: a client layer 210, a chassis layer 220 and a port layer 230. This is one possible way to arrange the apparatus 120. The three layers 210, 220, 230 may be combined in a single case and their components arranged differently.

The client layer 210 controls functions in the chassis layer 220. The client layer 210 may be disposed on client PC. The client layer 210 may have a number of functions, including displaying the available resources for a test (e.g., load modules and port-CPUs); configuring parameters for canned test sequences (control/data plane tests); managing saved configurations; passing configuration to middleware servers (e.g., to the chassis layer 220); controlling flow of tests (start/stop); and collecting and displaying test result data. Within the client layer 210 there is a user interface for test set up and control 215. The user interface 215 may include a GUI and/or a TCL API.

Within the chassis layer 220 there is a test manager 225 which is software operating on a chassis. The chassis and the client PC are communicatively coupled, so that the client layer 210 and the chassis layer 220 can interoperate. The chassis may have one or more cards, and the cards may have one or more ports. To control the ports, there may be one or more CPUs on each card. The test manager 225 controls processes residing on CPU enabled ports installed in the chassis.

The port layer 230 is responsible for all the details of communications channel configuration (e.g., IPSec or L2TP tunnels), negotiation, routing, traffic control, etc. Within the port layer 230 there is a port agent 233, and a number of set-up daemons 235. The set-up daemons 235 are for setting up communications parameters for use by the performance testing apparatus 120 in standards-based communications with the SUT 110 (i.e., in running performance tests). In FIG. 2, the performance testing system 120 includes three set-up daemons—a set-up daemon for a first vendor 235a, a set-up daemon for a second vendor 235b, and a set-up daemon 235c which conforms to the standard. Any number and combination of set-up daemons may be used, though at least two will normally be included, so that the performance testing apparatus 120 can be used to test standards-conforming SUTs and at least one vendor's non-conforming SUT.

The conforming set-up daemon 235c is for use if the SUT 110 conforms to the standard.

The non-conforming daemons 235a, 235b are adapted to moot standards-conformance deficiencies of the SUT 110, and are therefore for use if the SUT 110 does not conform to the standard. Non-conforming daemons may be respectively adapted to the peculiarities of specific vendors' implementations of standards. The non-conforming daemons may have a narrower focus, such as a product or product line. The non-conforming daemons may have a broader focus, such as a group of vendors or unrelated products. The essential aspect of the non-conforming daemons is that they permit performance testing of the SUT 110 using a standard despite the SUT's non-conformance to that standard.

The test manager 225 is for controlling the port layer 230 to generate data traffic for testing performance of the SUT 110 according to the standard. The test manager 225 sets up communication channels between the performance testing apparatus 120 and the SUT 110, controls generation of the test traffic, and characterizes the results back to the client layer 210.

Description of Processes

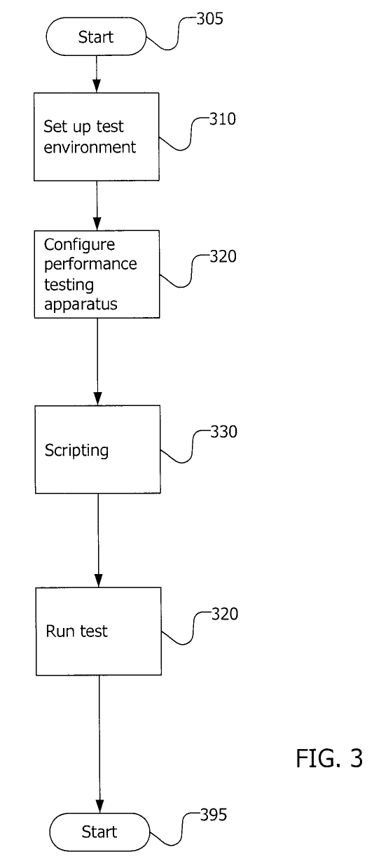

Referring now to FIG. 3, there is shown a flow chart of a process for testing performance of a SUT using a standard. The flow chart has both a start 305 and an end 395, but the process may be cyclical in nature.

As an initial matter, it may be necessary to set up the test environment (step 310). For example, it may be necessary to make physical connections of hardware, establish connections in software, etc. In some cases, the test environment may already be set up.

An end user may use an user interface to configure the performance testing apparatus (step 320). The user interface may be generic for the kind of performance test to be performed and for standards selected for use in the test. That is, the user interface may ignore actual and potential non-conformance of the SUT. The configuration step 320 may include, for example, designating ports in a test chassis, designating the type of test, and configuring a mode. The user may also specify distributions on the ports of tunnels, data units, etc. Distribution may be in absolute and/or relative terms.

The “mode” is whether the SUT conforms to a selected standard, or selection of a non-conforming implementation of a selected standard. In many cases, the mode select will impact the parameters requested from the user for each port, and the daemon and parameters delivered to each port. For example, the mode may correspond to the setup daemons 235 (FIG. 2) which will be downloaded to the ports.

Using a script language, the end user can specify additional or different parameters (step 330). Some or all of the scripting may take place prior to configuring the test apparatus (step 320). Indeed, the actions of the script may be to configure the test apparatus. The user may specify a script for implementing non-standard parameters. In such a circumstance, the user may input or otherwise provide the non-standard parameters during script operation, or as a consequence of the script's operation. The non-standard parameters can be using a set of Attribute-Value pairs (AVPs) specified either through the script API (e.g., a non-interactive or batch mode script) or through an user interface screen which allows the user to specify the AVPs in a two column table format.

Once the preparatory steps are complete, the performance testing apparatus may generate the data traffic for testing performance of the SUT (step 340). Once the test is initiated, the test generator 210 may provide appropriate data to each port based upon its mode.

Implementation for IPSec

After the key exchange is completed, the vendor-specific daemons pass control to a tunnel management module which conforms to the RFC. The effect is that the vendor-specific daemons “cover over” differences between the vendor-specific implementations and the RFC. In this way, the tunnels assigned to each port are supported.

Tunnel use, teardown and status can be handled in conformance with the RFC.

The following is a simplified IDL for testing of VPN capabilities of non-conforming SUTs. IDL is the abbreviation for Interface Definition Language, an industry standard specification format for interoperability when using a remote procedure call protocol called CORBA (Common Object Request Broker Architecture). Both IDL and CORBA are standards championed by an industry consortium called OMG (www.omg.org). There are many ways to specify common interfaces between disparate systems and components—CORBA is one of the more popular ones and is available across a variety of operating systems and devices.

```
    // - Chassis / Client Components -
    // (Highly abbreviated)
    interface VPNClient
    {
      void PostProgress(in string progress);
      void PostControlPlaneResult(in ControlPlaneResult cp_result);
      void PostDataPlaneResult(in DataPlaneResult dp_result);
    };
    struct TestConfig
    {
      /*
        Details of what ports to use, protocol distributions, so forth.
      */
    };
    interface TestManager
    {
      void StartTest(in TestConfig test_config, in VPNClient callback);
    };
    // - PCPU Level Control Plane -
    enum IPSECMODE { MODE_TUNNEL,
    MODE_TRANSPORT };
    enum ENCRYPTION_MODE { NULL, DES, 3DES,
AES128, AES192, AES256 };
    enum AUTH_ALGO { AUTH_ALGO_MD5,
    AUTH_ALGO_SHA1 };
    enum AUTH_MODE { AUTH_PSK, AUTH_RSA };
    enum DH_GROUP { DH1, DH2, DH5, DH14, DH15, DH16 };
    struct TunnelConfig
    {
    /*
```

Tunnel config is a large structure that describes every possible supported feature of the tunnel. This is one place where the vendor-specific daemons can cover over their differences from the RFC For the moment, this structure has been summarized. This is a matter of choice, and other technologies may obviate this.

| | |
|---|---|
| */ | |
| string id; | |
| boolean aggressive_IKE; | // Aggressive mode IKE? |
| boolean AH; | // AH encap? |
| boolean IPCOMP; | // IPCOMP encap? |
| boolean ESP; | // ESP encap? |
| boolean PFS; | // use PFS ? |
| boolean rekey; | // whether to rekey |

```
      // ADDR_FAMILY enum, allows mixed family tunnels
      (4/4,4/6,6/6,6/4)
      ADDR_FAMILY  addrType;
      ADDR_FAMILY  tunnelAddrType;
      // Enumeration definitions omitted
      AUTH_MODE  authMode;  // PSK / RSA
      ENCRYPTION_MODE p1EncryptionAlg;
      ENCRYPTION_MODE p2EncryptionAlg;
      AUTH_ALGO  p1AuthAlg;
      AUTH_ALGO  p2AuthAlg;
```

| | | |
|---|---|---|
| IPSECMODE | mode; | // tunnel vs. transport |
| DH_GROUP | dhGroup; | // Diffie-Hellman group |

```
      // Control re-trying if initial failure
      long retries;
      long retryTimerSeed;
      long retryTimerIncrement;
      // Lifetime parameters
      long ikeLifetime;
      long ipsecLifetime;
      //  - IP Topology -
      // Initiator
      string initiatorIp;
      string initNextHopIp;
      string initVpnSubnet;
      IP_ADDR_TYPE initClientAddrType;
      // Responder
      string responderIp;
      string respNextHopIp;
      string respVpnSubnet;
      IP_ADDR_TYPE respClientAddrType;
      string preSharedKey;
      string pubKeyData;  // the actual RSA public key
      string pubKeyId;  // for use with public key ike.
      // rekey / XAUTH / MODE-CFG / x509 / GRE / DPD
      cut for brevity
    };
    enum TUNNEL_STATUS
    {
      TUNNEL_OK,
      TUNNEL_DOWN,
      TUNNEL_PENDING,
      TUNNEL_ERROR,
      TUNNEL_WAITING,
      TUNNEL_TERMINATED,
      TUNNEL_ERROR_RETRY
    };
    struct Time
    {
      long secs;
      long usecs;
    };
    struct TunnelResult
    {
      /*
        This tells the TestManager statistics on the setup success / failure
times of tunnel negotiation.
      */
      string cfgId;
      TUNNEL_STATUS status;
      Time setupTime;
      Time phaseOneTime;
      Time phaseTwoTime;
      // [ . . . ]
    };
    typedef sequence <TunnelConfig> TunnelConfigs;
    typedef sequence <string> TunnelIds;
    interface TunnelMgr
    {
      void setConfigs(in TunnelConfigs tunnel_configs);
      Tunnels createTunnels(in TunnelIds tunnel_ids);
      // [ . . . ]
    };
    //  - PCPU Level Data Plane -
    // Connection : Description of endpoints used in a data transmission
    struct Connection
    {
      string src;
      string dst;
    };
    typedef sequence<Connection> ConnectionSequence;
    struct StreamDescription
    {
      ConnectionSequence connections;
      long  frame_length; // un-encapsulated
      long  xmit_length; // n frames
      long  duration;  // seconds
      unsigned short port; // src/dst port of UDP packets
    };
    // Query state of PCPU object
    struct TaskProgress
    {
      // take delta(bytes) / delta(last_op) from
      // 2 consecutive calls to get tx / rx rate.
```

| | |
|---|---|
| long long n_complete; | // how many packets sent / received |
| long long bytes; | // number of bytes sent / received |
| boolean done; | // done ? (transmit only) |
| Time first_op; | // time of first tx/rx for this stream |
| Time last_op; | // time of last tx/rx for this stream |

```
    };
    struct Progress
    {
      TaskProgress preparation;
      TaskProgress stream;
    };
    interface Transmitter
    {
      void SetOptions(in StreamDescription stream);
      void Prepare( );
      void StartTransmit( );
      void Stop( );
      Progress GetProgress( );
    };
    struct Receiver
    {
      void SetOptions(in StreamDescription stream);
      void Prepare( );
      void StartReceive( );
      void Stop( );
      Progress GetProgress( );
    };
    Closing Comments
```

The foregoing is merely illustrative and not limiting, having been presented by way of example only. Although examples have been shown and described, it will be apparent to those having ordinary skill in the art that changes, modifications, and/or alterations may be made.

Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

For any means-plus-function limitations recited in the claims, the means are not intended to be limited to the means disclosed herein for performing the recited function, but are intended to cover in scope any means, known now or later developed, for performing the recited function.

As used herein, “plurality” means two or more.

As used herein, a “set” of items may include one or more of such items.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of” respectively, are closed or semi-closed transitional phrases with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

It is claimed:

1. A performance testing apparatus for testing performance of a system under test using a standard, the apparatus comprising
plural set-up daemons for setting up communications parameters for use by the performance testing apparatus in communicating with the system under test, the daemons including
a conforming daemon which conforms to the standard, for use if the system under test conforms to the standard
a non-conforming daemon adapted to moot standards-conformance deficiencies of the system under test, for use if the system under test does not conform to the standard.

2. The performance testing apparatus of claim 1 further comprising
a test operations module for generating data traffic for testing performance of the system under test according to the standard.

3. The performance testing apparatus of claim 1 further comprising
a test manager for running a performance test of the system under test, the performance test comprising a test to determine how the system under test performs in response to specified conditions.

4. The performance testing apparatus of claim 1 comprising
a port layer for transmitting and receiving communications traffic with the system under test
a chassis layer for controlling the port layer
a client layer for controlling the chassis layer
wherein the set-up daemons are operable in the port layer.

5. A process for testing performance of a system under test using a standard, the process comprising
selecting a mode for at least one port
downloading to the ports a daemon corresponding to the mode selected for each respective port, the daemons for setting up communications parameters for use in communicating with the system under test, the daemons including
a conforming daemon which conforms to the standard, for use if the system under test conforms to the standard
a non-conforming daemon adapted to moot standards-conformance deficiencies of the system under test, for use if the system under test does not conform to the standard
providing data to the ports based upon their selected mode.

6. The process for testing performance of a system under test using a standard of claim 5 further comprising
selecting a test type
running a test of the selected type and collecting data on performance of the system under test.

7. The process for testing performance of a system under test using a standard of claim 6 wherein the test type comprises a stress test.

8. The process for testing performance of a system under test using a standard of claim 6 wherein the test type comprises a load test.

9. The process for testing performance of a system under test using a standard of claim 5 wherein
the mode identifies whether the system under test conforms to the standard, or identifies a non-conforming implementation of the standard.

10. A process for operating a performance testing apparatus to test performance of a system under test using a standard, wherein the system under test uses non-standard parameters, the process comprising
receiving a script for implementing the non-standard parameters
generating data traffic for testing performance of the system under test according to the standard and the script.

11. The process for operating a performance testing apparatus of claim 10 wherein testing performance comprises stress testing.

12. The process for operating a performance testing apparatus of claim 10 wherein testing performance comprises load testing.

13. A performance testing process for testing performance of a system under test using a standard, the process comprising
providing plural set-up daemons for setting up communications parameters for use in communicating with the system under test, the daemons including
a conforming daemon which conforms to the standard
a non-conforming daemon adapted to moot standards-conformance deficiencies of the system under test
selecting the conforming daemon if the system under test conforms to the standard
selecting the non-conforming daemon if the system under test does not conform to the standard.

14. The performance testing process of claim 13 further comprising
generating data traffic for testing performance of the system under test according to the standard.

15. The performance testing process of claim 13 further comprising
running a performance test of the system under test, the performance test comprising a test to determine how the system under test performs in response to specified conditions.

16. The performance testing process of claim 13 comprising
transmitting and receiving communications traffic with the system under test
controlling the port layer
controlling the chassis layer
wherein the set-up daemons are operable in the port layer.

17. An apparatus for testing performance of a system under test using a standard, the apparatus comprising
means for selecting a mode for at least one port
means for downloading to the ports a daemon corresponding to the mode selected for each respective port, the daemons for setting up communications parameters for use in communicating with the system under test, the daemons including
a conforming daemon which conforms to the standard, for use if the system under test conforms to the standard
a non-conforming daemon adapted to moot standards-conformance deficiencies of the system under test, for use if the system under test does not conform to the standard
means for providing data to the ports based upon their selected mode.

18. The apparatus for testing performance of a system under test using a standard of claim 17 further comprising
means for selecting a test type
means for running a test of the selected type and collecting data on performance of the system under test.

19. The apparatus for testing performance of a system under test using a standard of claim 18 wherein the test type comprises a stress test.

20. The apparatus for testing performance of a system under test using a standard of claim 18 wherein the test type comprises a load test.

21. The apparatus for testing performance of a system under test using a standard of claim 17 wherein
the mode identifies whether the system under test conforms to the standard, or identifies a non-conforming implementation of the standard.

22. A performance testing apparatus to test performance of a system under test using a standard, wherein the system under test uses non-standard parameters, the apparatus comprising
means for receiving a script for implementing the non-standard parameters
means for generating data traffic for testing performance of the system under test according to the standard and the script.

23. The performance testing apparatus of claim 22 wherein testing performance comprises stress testing.

24. The performance testing apparatus of claim 22 wherein testing performance comprises load testing.

25. An apparatus for testing performance of a system under test using a standard, the apparatus comprising
plural daemons for setting up communications parameters for use in communicating with the system under test, the daemons including
a conforming daemon which conforms to the standard, for use if the system under test conforms to the standard
a non-conforming daemon adapted to moot standards-conformance deficiencies of the system under test, for use if the system under test does not conform to the standard
software for downloading to the ports one of the daemons corresponding to a mode selected for each respective port
a test manager for controlling the ports to transmit data based upon their selected mode.

26. The apparatus for testing performance of a system under test using a standard of claim 25 further comprising
a user interface for allowing a user to select a test type
the test manager further for running a test of the selected type and collecting data on performance of the system under test.

27. The apparatus for testing performance of a system under test using a standard of claim 26 wherein the test type comprises a stress test.

28. The apparatus for testing performance of a system under test using a standard of claim 26 wherein the test type comprises a load test.

29. The apparatus for testing performance of a system under test using a standard of claim 25 wherein
the mode identifies whether the system under test conforms to the standard, or identifies a non-conforming implementation of the standard.

30. A performance testing apparatus to test performance of a system under test using a standard, wherein the system under test uses non-standard parameters, the apparatus comprising
a user interface for receiving a script for implementing the non-standard parameters
a test manager for controlling generation of data traffic for testing performance of the system under test according to the standard and the script.

31. The performance testing apparatus of claim 30 wherein testing performance comprises stress testing.

32. The performance testing apparatus of claim 30 wherein testing performance comprises load testing.
